(19) United States
(12) Patent Application Publication
(10) Pub. No.: US 2011/0299213 A1
(43) Pub. Date: Dec. 8, 2011

(54) VARISTOR CERAMIC, MULTILAYER COMPONENT COMPRISING THE VARISTOR CERAMIC, AND PRODUCTION METHOD FOR THE VARISTOR CERAMIC

(75) Inventors: Monika Piber, Anger (AT); Hermann Grünbichler, St. Josef (AT)

(73) Assignee: EPCOS AG, München (DE)

(21) Appl. No.: 13/144,646

(22) PCT Filed: Feb. 1, 2010
(86) PCT No.: PCT/EP10/51185

§ 371 Date: Aug. 16, 2011

(30) Foreign Application Priority Data
Feb. 3, 2009 (DE) 10 2009 007 235.7
Jun. 4, 2009 (DE) 10 2009 023 847.6

(51) Int. Cl. H05F 3/00; C04B 35/64; C04B 35/453

(52) U.S. Cl. 361/212; 501/152; 264/617

(57) ABSTRACT

A varistor ceramic includes Zn as the main component and Pr in a proportion of 0.1 to 3 atom %.

### RELATED APPLICATIONS

This is a §371 of International Application No. PCT/EP2010/051185, with an international filing date of Feb. 1, 2010 (WO 2010/089276 A1, published Aug. 12, 2010), which is based on German Patent Application No. 10 2009 007 235.7, filed Feb. 3, 2009, and German Patent Application No. 10 2009 023 847.6, filed Jun. 4, 2009, the subject matter of each of which is incorporated by reference.

### TECHNICAL FIELD

This disclosure relates to a varistor ceramic, methods for producing the varistor ceramic and multilayer components made from the varistor ceramic.

### BACKGROUND

Varistors are voltage-dependent resistors used for overvoltage protection.

A widespread problem of varistor ceramics is increasing switching capability in the high-current range (ESD, 8/20) while simultaneously achieving a sufficiently steep characteristic curve and at the same time a low and stable leakage current.

### SUMMARY

We provide a varistor ceramic comprising Zn as a main component, and Pr in a proportion of 0.1 to 3 atom %, based on the atom % of the ceramic.

We further provide a varistor ceramic comprising ZnO as the main component, Pr³⁺/Pr⁴⁺ in a proportion of 0.1 to 3 atom %, Co²⁺/Co³⁺ in a proportion of 0.1 to 10 atom %, Ca²⁺ in a proportion of 0.001 to 5 atom %, Si⁴⁺ in a proportion of 0.001 to 0.5 atom %, Al³⁺ in a proportion of 0.001 to 0.1 atom %, Cr³⁺ in a proportion of 0.001 to 5 atom %, and B³⁺ in a proportion of 0.001 to 5 atom %, all based on the atom % of the ceramic

We further provide a method for producing a varistor ceramic comprising calcining raw ceramic material, producing a slurry containing the raw ceramic material, preparing green foils from the slurry, debinding the green foils, and sintering debound green foils.

### BRIEF DESCRIPTION OF THE DRAWINGS

FIG. 1 shows the production process of multilayer varistors as a schematic flow diagram, comprising the process steps: A1 Initial weight, A2 Pre-grinding, A3 Drying, A4 Screening, A5 Calcination, A6 Post-grinding, A7 Drying, A8 Screening, B1 Slurrying, B2 Green foils, C1 Applying conductive paste, C2 Stacking, C3 Cutting, D1 Decarburizing, D2 Sintering, E1 Attaching external terminals, E2 Burn-in.

FIG. 2 shows the construction of a multilayer varistor schematically, comprising the inner electrodes (1), the varistor ceramic material (2), and the external terminals (3).

FIG. 3 shows the characteristic curve of an ESD pulse on the left, and the characteristic curve of an 8/20 pulse on the right.

### REFERENCE LIST

1) Inner electrode
2) Varistor ceramic material
3) External terminal

### DETAILED DESCRIPTION

We provide a varistor ceramic comprising the following materials:

Zn as the main component, and

Pr in a proportion of 0.1 to 3 atom %, based on the atom % of the ceramic varistor.

The Zn may be present as Zn²⁺ and the Pr as Pr³⁺/Pr⁴⁺.

The proportion of Co may be in a range from 0.1 to 10 atom %, wherein the Co is preferably present as Co²⁺/Co³⁺.

The proportion of Ca may be in a range from 0.001 to 5 atom %, wherein the Ca is preferably present as Ca²⁺.

The proportion of Si may be in a range from 0.001 to 0.5 atom %, wherein the Si is preferably present as Si⁴⁺.

The proportion of Al may be in a range from 0.001 to 0.01 atom %, wherein the Al is preferably present as Al³⁺.

The proportion of Cr may be in a range from 0.001 to 5 atom %, wherein the Cr is preferably present as Cr³⁺.

The proportion of B may be in a range from 0.001 to 5 atom %, wherein the 13 is preferably present as B³⁺.

We provide a material composition suitable for multilayer varistors, wherein zinc oxide may be used as the main component, oxides of praseodymium (0.1-3 atom %) and cobalt (0.1-10 atom %) being added as dopants and additionally calcium (0.001-5 atom %), silicon (0.001-1 atom %), aluminium (0.001-0.1 atom %), chromium (0.001-5 atom %) in oxide form and boron in bonded form (0.001-5 atom %) being added.

A range of 0.001-0.01 atom % for aluminium is preferred.

In that manner, improved nonlinearity, reproducibility and stability in the high-current range (ESD, 8/20) are achieved relative to the current state of the art, while lower leakage current is simultaneously achieved due to the high grain boundary resistance. The advantages listed are described in detail below.

The varistor ceramic can be processed to give multilayer components in a suitable process, the multilayer components exceeding the previous solutions with regard to nonlinearity, reproducibility, ESD stability, peak current stability and leakage current.

The varistor ceramic may comprise the ZnO material system as a basis, and the oxides of praseodymium (0.1-3 atom %) and cobalt (0.1-10 atom %) as dopants and additionally calcium (0.001-5 atom %), silicon (0.001-0.5 atom %), aluminium (0.001-0.1 atom %), chromium (0.001-5 atom %) in oxide form, and boron in bonded form (0.001-5 atom %).

A range of 0.001-0.01 atom % for aluminium is preferred.

The varistor ceramic may comprise ZnO as the main component, Pr³⁺/Pr⁴⁺ in a proportion of 0.1 to 3 atom %, Co²⁺/Co³⁺ in a proportion of 0.1 to 10 atom %, Ca²⁺ in a proportion of 0.001 to 5 atom %, Si⁴⁺ in a proportion of 0.001 to 0.5 atom %, Al³⁺ in a proportion of 0.001 to 0.1 atom %, Cr³⁺ in a proportion of 0:1001 to 5 atom % and B³⁺ in a proportion of 0.001 to 5 atom %.

The ceramic body of the multilayer varistor may be present as a monolithic ceramic body.

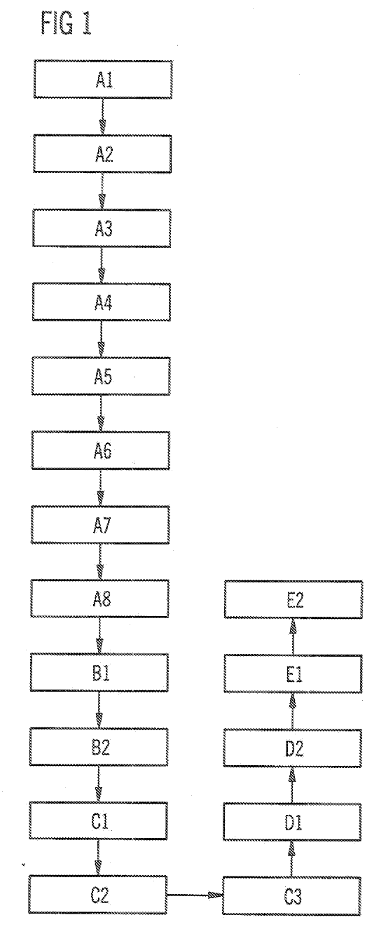

The production of the multilayer varistor can take place according to FIG. 1.

The ratio of the elements of the varistor material may be 97.8 atom % Zn, 1.5 atom % Co, 0.1 atom % Cr, 0.02 atom % Si, 0.02 atom % Ca, 0.002 atom % B and 0.006 atom % Al. The components, in oxidized or bonded form in the ratios indicated above, are weighed (A1), pre-ground (A2), dried (A3), screened (A4), and then calcined (A5) at between 400° C. and 1000° C., post-ground (A6), spray-dried (A7), and screened (A8).

A slurry is produced from the obtained powder by adding a binder, dispersing agent, and solvent (B1), from which foils having a layer thickness of between 5 and 60 μm are drawn (B2), the foils subsequently being processed in a manner analogously to the process diagram in FIG. 1, forming multilayer varistors. The green foils have a conductive paste applied (C1), are stacked and are then cut (C2, C3).

The binder is burned out of the green parts at temperatures between 180° C. and 500° C. in the next decarburization step (D1), and the components are sintered at a temperature between 1100 and 1400° C. (D2). The external terminal layer (E1) is then applied, and the layer burned at temperatures between 600° C. and 1000° C. (E2).

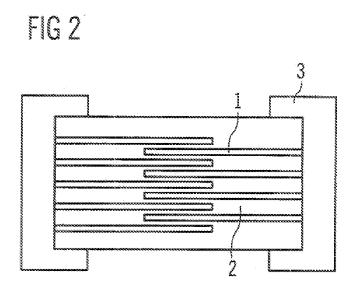

FIG. 2 shows a schematic side view of a multilayer component. The inner electrodes (1) and the layer of varistor ceramic material (2) follow an alternating sequence here. The inner electrodes (1) are in each case connected alternately to one or the other of the external terminals (3). In the center region, the inner electrodes overlap each other (1).

A typical construction of a 0402 multilayer varistor (dimensions 1.0 mm×0.5 mm×0.5 mm) is shown in FIG. 2, wherein the overlap area of the inner electrodes (2) and the number of inner electrodes can be adapted to the desired electrical component characteristics.

The electrical characterization of the components takes place by determining the leakage current, the varistor voltage, the coefficient of nonlinearity, the 8/20 pulse stability, the ESD pulse stability and the 8/20 terminal voltage at 1 A (U_{K}).

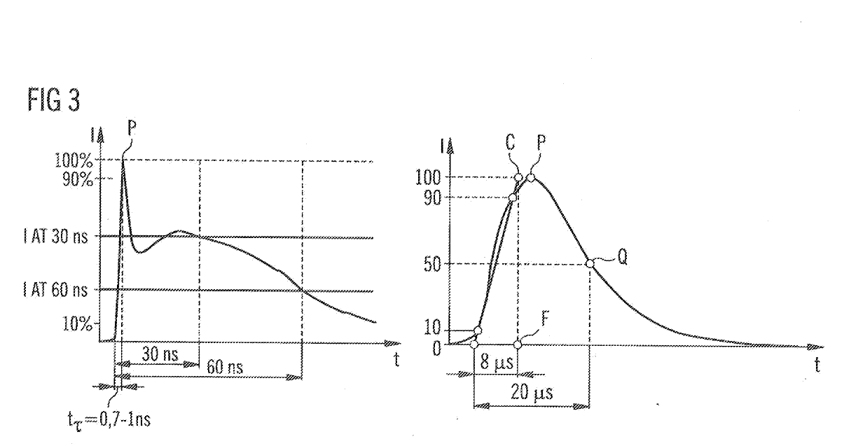

FIG. 3 shows one pulse curve in each case on the left and right. The current I is plotted against time t in each case.

The varistor voltage U_{V} is determined at 1 mA. The leakage current I_{L} is measured at a voltage of 3.5 V. The ESD stability is determined from pulses in FIG. 3. To this end, the components are subjected to +/−10 ESD pulses (see FIG. 3, right). The percentage change in U_{V} before and after pulsing, and the leakage current in percent before and after pulsing are calculated and must not show a percentage change of greater than 10%. Additionally, 8/20 robustness tests are performed (see FIG. 3, right, for pulse shape). The components are subjected to 8/20 pulses (see FIG. 3, right) at 1 A, 5 A, 10 A, 15 A, 20 A and 25 A, and the percentage change in the varistor voltage and the leakage current after loading are determined.

The coefficients of nonlinearity are determined according to the following equations:

α₁(10 μA/1 mA)=log (1*10⁻³/10*10⁻⁶)/log (V_{10 mA}/V_{10 μA})

α₂(1 mA/1 A)=log (1/1*10⁻³)/log (V_{1 A}/V_{1 mA})

α₃(1 mA/20 A)=log (20/1*10⁻³)/log (V_{20 A}/V_{1 mA})

Stability tests are performed with 80% AVR at 125° C., wherein the leakage current I_{L} should not have a rising characteristic under said conditions.

TABLE 1
Electrical results

| | Uᵥ | | | | | | | ESD |
|---|---|---|---|---|---|---|---|---|
| | [V] | I_{L} [μA] | U_{K} [V] | α₁ | α₂ | α₃ | 8/20 Stabil. | Stab. |
| Standard | 6.1 | <1 | <15 | 13 | 8.5 | 7.0 | >25 A | >30 kV |
| material | | | | | | | | |

Table 1 shows the measured electrical values of the tested components with a varistor voltage of 6.1 V and a leakage current<1 μA. The coefficient of nonlinearity α₁ was 13, α₂ was 8.5 and α₃ was 7.0. The 8/20 terminal voltage U_{K} at 1 A, determined using an 8/20 pulse, is less than 15 V, and the components withstood an 8/20 pulse of 25 A without the characteristic curve changing more than 10% in the leakage current area or in the varistor voltage area. It was possible to subject the components to ESD pulses of 30 kV according to the Human Body Model with no change in leakage current or varistor voltage. The stability test under the above mentioned conditions showed a constant or slightly falling leakage current characteristic for a load duration of 500 hours. Intermediate measurements and final measurements of the varistor parameters U_{V}, and I_{L} showed a percentage change in the values of less than 2% after loading the components at 80% AVR at 125° C.

Variations in silicon concentration, cobalt and praseodymium concentration, and aluminium content show the batch reproducibility and robustness of the ceramic composition with regard to variations in initial weighing. For all variations of the ceramic composition, a variation in the chemical composition of the varistor ceramic causes only a negligible change in the electrical characteristic values of the current/voltage curve and the consistency with regard to 8/20 pulses and ESD pulses. Variations in composition in Table 2 and Table 4, and the corresponding electrical characteristic values in Table 3 and Table 5, confirm this finding.

TABLE 2
initial weighing: (units in atom %)

| Material | Zn | Pr | Co | Cr | Si | Ca | B | Al |
|---|---|---|---|---|---|---|---|---|
| A | 97.8 | 0.5 | 1.6 | 0.1 | 0.02 | 0.02 | 0.002 | 0.006 |
| B | 97.8 | 0.5 | 1.6 | 0.1 | 0.04 | 0.02 | 0.002 | 0.006 |
| C | 97.8 | 0.5 | 1.6 | 0.1 | 0.14 | 0.02 | 0.002 | 0.006 |

TABLE 3
Electrical results

| | | | | | | 8/20 | |
|---|---|---|---|---|---|---|---|
| Material | Uv [V] | I_{L} [μA] | α₁ | α₂ | α₃ | Stability | ESD Stability |
| A | 6.1 | <1 | 13.0 | 8.4 | 7.0 | >25 A | >30 kV |
| B | 6.5 | <1 | 13.6 | 8.6 | 7.4 | >25 A | >30 kV |
| C | 7.1 | <0.5 | 11.3 | 8.3 | 7.2 | >20 A | >30 kV |

TABLE 4
initial weighing: (units in atom %)

| Material | Zn | Pr | Co | Cr | Si | Ca | B | Al |
|---|---|---|---|---|---|---|---|---|
| A | 97.8 | 0.5 | 1.6 | 0.1 | 0.02 | 0.02 | 0.002 | 0.006 |
| D | 97.8 | 0.55 | 1.5 | 0.1 | 0.02 | 0.02 | 0.002 | 0.006 |
| E | 97.5 | 0.55 | 1.8 | 0.1 | 0.02 | 0.02 | 0.002 | 0.006 |
| F | 97.4 | 0.6 | 1.8 | 0.1 | 0.02 | 0.02 | 0.002 | 0.006 |
| G | 97.8 | 0.6 | 1.5 | 0.1 | 0.02 | 0.02 | 0.002 | 0.006 |

TABLE 5
Electrical results

| | | | | | | | ESD |
|---|---|---|---|---|---|---|---|
| Material | Uv [V] | I_{L} [μA] | α₁ | α₂ | α₃ | 8/20 Stability | Stability |
| A | 6.1 | <1 | 13.0 | 8.4 | 7.0 | >25 A | >30 kV |
| D | 6.9 | <0.4 | 12.7 | 9.7 | 7.4 | >25 A | >30 kV |
| E | 7.4 | <0.5 | 15.8 | 9.5 | 7.3 | >25 A | >30 kV |
| F | 7.1 | <0.4 | 14.2 | 10.1 | 7.9 | >25 A | >30 kV |
| G | 7.9 | <0.03 | 20.1 | 9.4 | 7.6 | >25 A | >30 kV |

The proportion of Zn, which is used as the oxide, may preferably be greater than 90 atom %.

The proportion of Pr may preferably be in a range from 0.5 to 0.6 atom %.

The proportion of Co may preferably be in a range from 1.5 to 2.0 atom %.

The proportion of Ca may preferably be in a range from 0.01 to 0.03 atom %.

The proportion of Si may preferably in a range from 0.01 to 0.15 atom %.

The proportion of Al may preferably be in a range from 0.005 to 0.1 atom-%, particularly preferably in the range from 0.005 to 0.01 atom %.

The proportion of Cr may preferably be in a range from 0.05 to 0.2 atom %.

The proportion of B may preferably be preferably in a range from 0.001 to 0.01 atom %.

The varistor ceramic may have a sinter temperature of between 900 and 1200° C., preferably in the range from 1100° C. to 1200° C.

Owing to the avoidance of alkali metal carbonate additives, high reproducibility can be achieved in technical process control.

By avoiding alkali metal compounds in the formulation, a substantial improvement in reproducibility of the process control in wet chemical processing steps is achieved. The result is a low sample variance and at the same time improved batch reproducibility. By using boron compounds, which release boric oxide as a sintering aid only at relatively high temperatures, the sinter temperature can be reduced to below 1200° C. without alkali metal oxide additives, resulting in an advantageous microstructure development having a defined construction of the barriers in the grain boundary area, which forms during controlled cooling in air.

In the production method, boric oxide can be released from suitable precursors in the high temperature range for use as a sintering aid for controlling microstructure development, while avoiding evaporation losses.

The multilayer varistors of types 0402 and 0201 are characterized by excellent results for leakage current, ESD stability, 8/20 robustness, long-term stability, and nonlinearity.

“Main component” is understood as meaning a proportion of at least 50 atom %. The proportion of Zn is preferably greater than 70 atom %.

The production method may comprise the process steps:

a) calcining the raw ceramic material,

b) producing a slurry,

c) preparing green foils,

d) debinding the green foils, and

e) sintering the green foils from d).

The method may additionally comprise between process steps d) and e) the process step d1) constructing a component.

Boric oxide may be released by a boric oxide precursor, or may be added in the form of a glass comprising boron.

1-15. (canceled)

16. A varistor ceramic comprising:
Zn as a main component, and
Pr in a proportion of 0.1 to 3 atom %, based on the atom % of the ceramic.

17. The varistor ceramic according to claim 16, further comprising Co in a proportion of 0.1 to 10 atom %, based on the atom % of the ceramic.

18. The varistor ceramic according to claim 16, further comprising Ca in a proportion of 0.001 to 5 atom %, based on the atom % of the ceramic.

19. The varistor ceramic according to claim 16, further comprising Si in a proportion of 0.001 to 0.5 atom %, based on the atom % of the ceramic.

20. The varistor ceramic according to claim 16, further comprising Al in a proportion of 0.001 to 0.01 atom %, based on the atom % of the ceramic.

21. The varistor ceramic according to claim 16, further comprising Cr in a proportion of 0.001 to 5 atom %, based on the atom % of the ceramic.

22. The varistor ceramic according to claim 16, further comprising B in a proportion of 0.001 to 5 atom %, based on the atom % of the ceramic.

23. The varistor ceramic according to claim 16, further comprising:
Co in a proportion of 0.1 to 10 atom %,
Ca in a proportion of 0.001 to 5 atom %,
Si in a proportion of 0.001 to 0.5 atom %,
Al in a proportion of 0.001 to 0.01 atom %,
Cr in a proportion of 0.001 to 5 atom %, and
B in a proportion of 0.001 to 5 atom %, all based on the atom % of the ceramic.

24. A varistor ceramic comprising:
ZnO as a main component,
Pr³⁺/Pr⁴⁺ in a proportion of 0.1 to 3 atom %,
Co²⁺/Co³⁺ in a proportion of 0.1 to 10 atom %,
Ca²⁺ in a proportion of 0.001 to 5 atom %,
Si⁴⁺ in a proportion of 0.001 to 0.5 atom %,
Al³⁺ in a proportion of 0.001 to 0.1 atom %,
Cr³⁺ in a proportion of 0.001 to 5 atom %, and
B³⁺ in a proportion of 0.001 to 5 atom %, all based on the atom % of the ceramic.

25. The varistor ceramic according to claim 23, which is substantially free of further metals.

26. The varistor ceramic according to claim 16, having a sinter temperature of 900 to 1200° C.

27. The varistor ceramic according to claim 16, which is substantially free of alkali metal compounds.

28. The multilayer component comprising a varistor ceramic according to claim 16, configured for an ESD protection.

29. A method for producing a varistor ceramic comprising:
a) calcining raw ceramic material,
b) producing a slurry containing the raw ceramic material,
c) preparing green foils from the slurry,
d) debinding the green foils,
e) sintering debound green foils.

30. The method according to claim 29, wherein boric oxide is released by a boric oxide precursor, or is added in the form of a glass comprising boron.

31. The method according to claim 29, wherein the varistor ceramic comprises Zn as a main component and Pr in a proportion of 0.1 to 3 atom %, based on the atom % of the ceramic.
